(19) United States
(12) Patent Application Publication
(10) Pub. No.: US 2004/0146140 A1
(43) Pub. Date: Jul. 29, 2004

(54) Pipeline wall inspection apparatus

(76) Inventor: James McCain, Channahon, IL (US)

Correspondence Address: Ernest S. Kettelson, KETTELSON LAW OFFICES, LTD., Wynderidge Place, Post Office Box 2517, Joliet, IL, 60434, US

(21) Appl. No.: 10/348,562

(22) Filed: Jan. 29, 2003

(51) Int. Cl. G01B 15/06

(52) U.S. Cl. 378/59

(57) ABSTRACT

Apparatus to inspect sections of a pipeline wall at the site where the pipeline is located, comprising a vehicle in which to install and transport such apparatus to the pipeline site, a radiographic camera operably installed in said vehicle, a computer with monitor installed in said vehicle, a digital scanner installed in said vehicle, flexible phosphor sheets carried in said vehicle on which to impinge radiographic images respective sections of said pipeline wall that are to be inspected, a flexible carrier to receive a respective one of said phosphor sheets and to mount adjacent a said section of said pipeline wall that is to be inspected and on which radiographic rays from said radiographic camera are impinged after passing through said pipeline wall to record on said phosphor sheet the characteristics of said section of pipeline wall, such flexible phosphor sheet with said radiographic images thereon to be run through said digital scanner to convert the radiographic images to corresponding digital graphic information which is then fed to the said computer and in turn transmitted to the monitor for display of said digitized graphic information on said viewing screen, and including the method of using such apparatus to inspect respective section of a pipeline wall on the site at which such pipeline is located.

### FIELD OF THE INVENTION

This invention relates to the field of examining the integrity of the walls of pressurized vessels, in particular the walls of pipelines, and doing so without emptying the contents thereof. The invention is able to determine cracks, holes, and other flaws in the peripheral wall of a pipeline while crude oil, gasoline or other substance is still flowing therein under pressure, and to display the results on a computer screen.

### BACKGROUND OF THE INVENTION

Prior art methods of examining pipelines to determine the integrity of the peripheral wall of the pipeline have required that the pipeline be emptied. When the peripheral wall is examined by radiography in the prior art, individual X-Ray plates have been placed adjacent respective sections of the outer peripheral wall and the X-Ray camera sequentially positioned to direct X-Ray beams through the respective wall sections. The X-Ray plates have then been placed on a back lighted viewer screen and visually examined. Each plate is compared with a control plate that shows the results of a known section of the pipeline that does not have any defects. Any differences in each plate being analyzed from the control plate are then noted for further examination to determine whether any differences are in fact defects in the pipeline peripheral wall, and if so the exact nature of the defect.

### SUMMARY OF THE INVENTION

The present invention includes a flexible carrier in which to mount a flexible phosphor imaging plate, the flexible carrier and plate mounted therein being strapped or otherwise secured to a section of the outer peripheral wall of the pipeline that is to be examined. A portable X-Ray camera is then positioned to direct radiographic rays or X-Ray beams through the peripheral wall of the pipeline on to the phosphor plate. Successive sections of the pipeline peripheral wall are examined in the same way. The flexible phosphor plates are then carried to a computer installation, where each plate is placed over the pickup surface of a computer scanner which reads the surface of the phosphor plate and converts the variations and characteristics shown thereon to digital signals which are then transmitted to the hard disk of the computer. The digital signals may then be transmitted to the monitor screen of the computer for display of the pipeline wall characteristics picked up by the original phosphor plate when impinged thereon by the X-Ray beams or radiographic rays transmitted by the X-Ray camera. A crack, or hole, or other defect or flaw in the pipeline wall will show a distinctively different representation on the phosphor plate and on the computer screen than adjacent sections of the pipeline wall which do not have any flaws or defects.

To eliminate the need for emptying the contents of the pipeline before taking the radiographic pictures of sections of the pipeline wall, the radiographic camera is calibrated to reproduce substantially the same radiographic image quality on the flexible phosphor plate when the pipeline is full as when it is empty. A control (calibration) image is made on a mock-up of the existing section of pipeline. The mock-up should be of equal wall thickness as the section of pipeline to be tested and filled with a relatively similar fluid as in the operating pipeline. At least one through going hole is drilled in the pipe wall of the mock-up. This hole will need to be located in the Top Dead Center (TDC) of the pipe laid in the horizontal position. Additional partial through holes may be placed near the through hole. These holes can be from either or both the ID and OD of the pipe representing various known remaining wall thickness (i.e. ¼ Wall, ½ Wall, ¾ Wall). An image made from a mock-up can be used to calibrate the computer with the image of the hole being 0 thickness and the full wall adjacent to the through hole being the actual wall thickness. The computer will then be able to determine single wall thickness through the double wall pipe and the fluid contained in the pipe. The calibration can be used on any section of pipeline with the same diameter, thickness, fluid and exposure parameters. The pipeline can be inspected without calibration when conditions are favorable to perform ultrasonic thickness measurements to determine remaining wall thickness. This process gives more information as to the size and characteristics of an anomaly than presently utilized methods.

The components in accordance with this invention are portable, so the invention may be utilized at the site of the pipeline that is to the examined.

### BRIEF DESCRIPTION OF THE DRAWING

FIG. 1 is a perspective view of the interior of a truck chamber having therein a computer, a monitor having a viewing screen, a digital scanner, a portable radiographic camera, a flexible phosphor sheet on which to impinge radiographic rays from said portable radiographic camera passing through a respective section of pipeline wall to record the radiographic image characteristics of said section of pipeline wall that is being inspected, and a flexible carrier to receive said flexible phosphor sheet therein to hold in place against the section of pipeline wall that is to be inspected.

FIG. 2 is an elevation view of a section of a pipeline.

FIG. 3 is a cross section view of the pipeline seen in FIG. 2

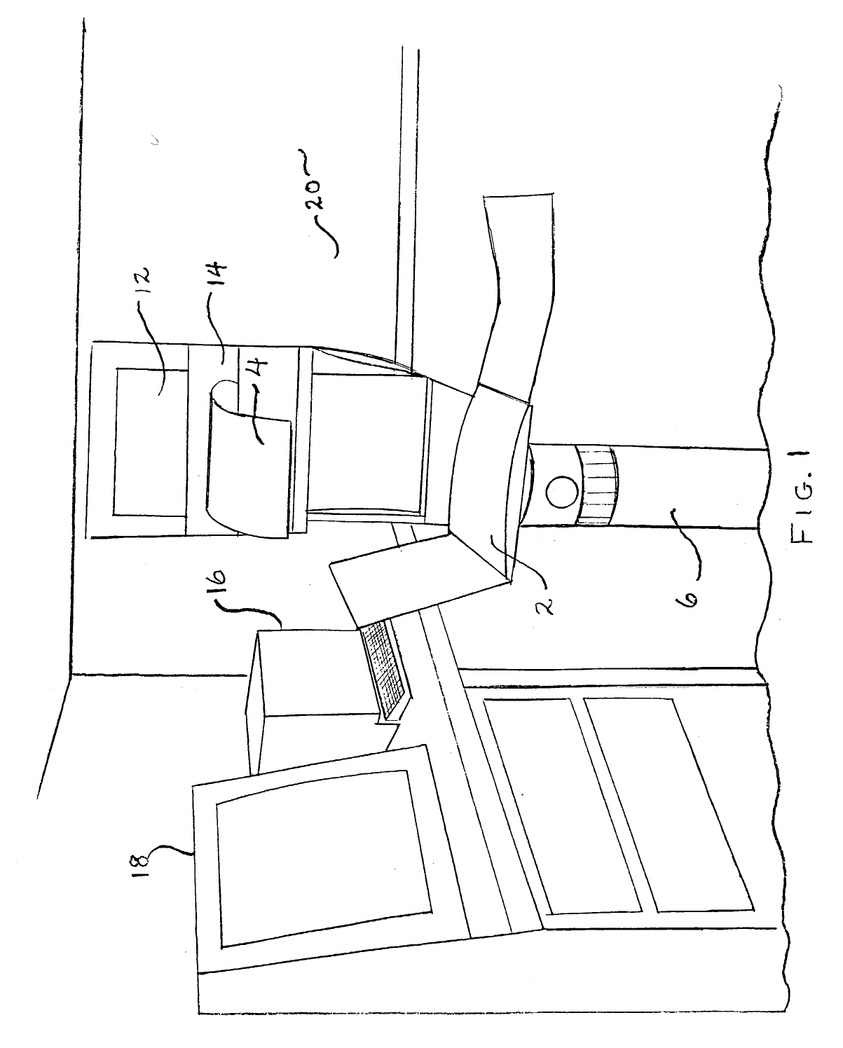

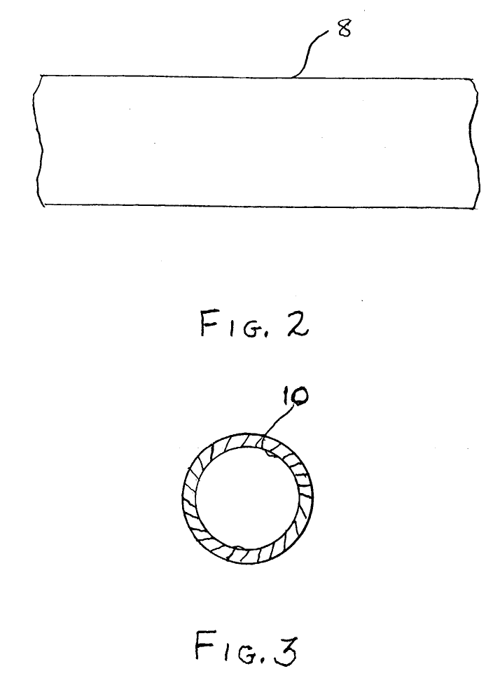

### DESCRIPTION OF PREFERRED EMBODIMENT

In accordance with this invention, a flexible carrier assembly 2 is provided in which to mount a flexible phosphor plate 4 of the kind needed to retain and display radiographic images impinged thereon by radiographic rays transmitted through a subject that is positioned between the phosphor plate 4 and the radiographic or X-Ray camera 6. To examine a section of a pipeline 8 with its contents still flowing therein, the radiographic camera 6 is first calibrated so the intensity of the radiographic rays transmitted therefrom produce images on the phosphor plate 4 that corresponds with images on a phosphor plate produced by the camera before calibration taken on an empty section of pipeline.

To make the examination on site where the underground pipeline is located, the section to be examined is first exposed by digging. The flexible phosphor plate 4 is placed in the flexible carrier assembly 2 which is then placed on the exterior of the section of pipeline wall 10 that is to be inspected. The radiographic camera 6 is then put in position to direct its radiographic waves or rays at the portion of the pipeline wall 10 at which the phosphor plate 4 has been placed on the opposite side thereof. The camera 6 is then activated to direct radiographic waves at that portion of the pipeline wall 10 and through the wall 10 as well as through the phosphor plate 4 on which the cross-sectional characteristics of the inspected section of the pipeline wall are impinged.

The phosphor plate 4 is then removed from the pipeline wall 10 and from its carrier assembly 2. It is then placed on the pick-up surface 12 of a digital scanner 14 which when energized reads the surface of the phosphor plate 4 and converts the variations and characteristics shown thereon to digital signals that are then transmitted to the hard disk of a computer 16 connected to the scanner 14. The digital signals on the hard disk of the computer 16 may then be transmitted to the screen of the computer monitor 18 to display the characteristics of the pipeline wall 10 that were picked up by the radiographic camera 6 on the phosphor plate 4, including those characteristics that indicate non-defective wall portions and those different characteristics that indicate any defective wall portions.

The entire apparatus may be carried or mounted in a truck compartment 20 or in a room or compartment of some other mobile vehicle for transport to the site of the pipeline sections that are to be examined. The various sections of the pipeline 10 that are to be inspected have respective flexible phosphor plates 4 put in place as described above, and the operator of the radiographic camera 6 takes respective radiographic or X-Ray pictures of each. Those plates 4 are matched with the respective sections of the pipeline they represent and identified as such. They are then scanned by the scanner 14 and the digital signals of each transmitted to the hard disk of the computer 16 where they are properly identified. When all of the data from the respective phosphor plates 4 have been loaded in the computer 16 and respectively identified as to which section of the pipeline 10 each represents, those data may then be transmitted to the screen of the computer monitor 18 also carried in the truck compartment 20. If desired, this may all be done immediately at the site so any defects in the pipeline wall 10 may be learned without delay.

I claim:

1. A pipeline wall inspection apparatus, comprising a phosphor plate on which to impinge radiographic images, a carrier to receive said phosphor plate and hold it in position against the wall of a section of pipeline, a radiographic camera positionable to direct radiographic rays through said section of pipeline and on to said phosphor plate held by said carrier, a digital scanner to receive and scan said phosphor plate, said phosphor plate being then removable from said carrier and placed on said digital scanner for viewing the radiographic images on said phosphor plate and to convert said images to corresponding digital signals, a computer having a hard disk connected to said digital scanner and a monitor having a viewing screen connected to said computer, said scanner transmitting said digital signals obtained from said radiographic images on said phosphor plate to said hard disk of said computer, said computer transmitting said digital signals to said viewing screen of said monitor for visual inspection of the said section of pipeline originally impinged on said phosphor plate by said radiographic rays.

2. A pipeline wall inspection apparatus as set forth in claim 1, wherein said phosphor plate comprises a flexible sheet.

3. A pipeline wall inspection apparatus as set forth in claim 1, wherein said carrier comprises a flexible sheet.

4. A pipeline wall inspection apparatus as set forth in claim 1, wherein said radiographic camera is portable.

5. A pipeline wall inspection apparatus as set forth in claim 1, including a vehicle having a work room mounted thereon, all of said pipeline wall inspection apparatus being received in and operable in said work room for transport to and use at the site of a pipeline whose wall sections are to be inspected and for inspection of said pipeline wall sections while at such on-site location.

6. A method of inspecting the wall of a section of pipeline on site, comprising the steps of installing a radiographic camera in a vehicle, a digital scanner in said vehicle, a computer in said vehicle, a monitor having a viewing screen and a power source in said vehicle to operate said radiographic camera, said digital scanner, said monitor, and said computer, providing flexible phosphor sheets in said vehicle on which to record radiographic images taken of a section of said pipeline wall, and providing a flexible sheet carrier to receive and hold a one of said flexible phosphor sheets in position adjacent a said section of said pipeline wall that is to be inspected, and including the step of transporting said vehicle and said items installed and received therein to the site of a pipeline that is to be inspected.

7. The method of inspecting the wall of a section of pipeline on site as set forth in claim 6, including the steps of taking a one of said phosphor sheets, placing it in said flexible sheet carrier, placing said flexible sheet carrier and flexible phosphor sheet therein against a section of said wall of said pipeline to be inspected, taking said radiographic camera and positioning it to direct radiographic rays through said section of said wall of said pipeline and through said phosphor sheet held thereagainst to impinge radiographic images of the characteristics of said section of said pipeline wall thereon.

8. The method of inspecting the wall of a section of pipeline on site as set forth in claim 7, including the steps of removing said flexible sheet carrier and said flexible phosphor sheet from said wall of said pipeline, placing said phosphor sheet on said digital scanner and operating said scanner to transform said radiographic images on said phosphor sheet to digital information and transfer such digital information to said computer, and operating said computer to process said digital information into digitized graphic images and then transmit said digitized graphic images to said viewing screen of said monitor to display said digitized graphic images showing the characteristics of said section of said pipeline wall that was inspected in accordance with said method.
